(19) United States
(12) Patent Application Publication
(10) Pub. No.: US 2008/0180242 A1
(43) Pub. Date: Jul. 31, 2008

(54) MICRON-SCALE IMPLANTABLE TRANSPONDER

(76) Inventor: Hugh V. COTTINGHAM, Caldwell, NJ (US)

Correspondence Address: STROOCK & STROOCK & LAVAN LLP, 180 MAIDEN LANE, NEW YORK, NY, 10038, US

(21) Appl. No.: 12/014,179

(22) Filed: Jan. 15, 2008

Related U.S. Application Data
(60) Provisional application No. 60/898,262, filed on Jan. 29, 2007.

(51) Int. Cl. G08B 1/08

(52) U.S. Cl. 340/539.12

(57) ABSTRACT

A miniaturized implantable transponder in which all components, including the antenna, are fully integrated into a single microchip that has a conformal coating that consists of a polymeric substance that is applied by vapor deposition techniques resulting in reduced volume versus the typical implantable transponder and reduces the volume size of the typical implantable transponder to enable easier implantation in a patient virtually eliminating implantation trauma in a patient.

### CROSS REFERENCE TO RELATED APPLICATION

This application claims the benefit of provisional application Ser. No. 60/898,262 filed on Jan. 29, 2007 entitled “MICRON-SCALE IMPLANTABLE TRANSPONDER”, the entire disclosure of which is incorporated herein by reference.

### BACKGROUND OF THE INVENTION

1. Field of Invention

The present invention relates generally to a micron-scale implantable transponder used to remotely monitor a person, animal or object and a system and method for utilizing the same.

2. Description of Related Art

Implantable Radio Frequency Identification Device (“RFID”) passive transponders are well known in the art.

Historically, implantable RFID transponders have traditionally been derived from animal implantable RFID transponders. Implantable RFID transponders typically operate in the range of 100-150 kHz. Due to the small area of the RFID antenna coil it typically has been necessary to optimize the antenna by including a ferrite core.

The following patents discuss the use of RFIDs in different transponders and are each incorporated herein by reference: U.S. Pat. No. 4,681,111 entitled “Analog and Digital Telemetry System for Implantable Device”; U.S. Pat. No. 4,992,794 entitled “Transponder and Method for the Production Thereof”; U.S. Pat. No. 5,025,550 entitled “Automated Method for Manufacture of Small Implantable Transponder Devices”; U.S. Pat. No. 5,211,129 entitled “Syringe-Implantable Identification Transponder”; U.S. Pat. No. 5,223,851 entitled “Apparatus for Facilitating Interconnection of Antenna Lead Wires to an Integrated Circuit and Encapsulating the Assembly to Form an Improved Miniature Transponder Device”; U.S. Pat. No. 5,252,962 entitled “System Monitoring Programmable Implantable Transponder”; U.S. Pat. No. 5,422,636 entitled “System Monitoring Programmable Implantable Transponder”; U.S. Pat. No. 5,523,616 entitled “Semiconductor Device Having Laminated Tight and Coarse Insulating Layers”; U.S. Pat. No. 5,724,030 entitled “System Monitoring Reprogrammable Implantable Transponder”; U.S. Pat. No. 5,767,792 entitled “Method for Calibrating a Temperature Sensing Transponder”; U.S. Pat. No. 5,481,262 entitled “System Monitoring Implantable Transponder”; U.S. Pat. No. 6,054,935 entitled “System Monitoring Programmable Implantable Transponder; U.S. Pat. No. 6,400,338 entitled “Passive Integrated Transponder Tag with Unitary Antenna Core”; and U.S. Pat. No. 6,647,299 entitled “Patient Programmer for Implantable Medical Device with Audio Locator Signal”.

The use of ferrite, which is a ferrous ceramic well known in the art for its magnetic properties, in antennas for implantable RFID passive transponders is common because it increases the magnetic permeability of the antenna, substantially increasing the inductance and thereby the distance over which the transponder can send and receive signals. A ferrite core based antenna, which is used to receive and transmit RF energy, is an element that is commonly found in prior art implantable RFID passive transponders. The use of ferrite in a transponder is disclosed for example in U.S. Pat. No. 4,681,111 which discloses the use of ferrite coils, ferrite sticks or ferrite beads to facilitate the transfer of power to an implanted device; U.S. Pat. No. 4,992,794, which discloses a cylindrical ferrite core with a recess used in an implantable transponder; U.S. Pat. No. 5,211,129, which discloses a coil former used in a transponder that is formed of ferrite; U.S. Pat. No. 5,252,962, which discloses antennas used in a transponder that are formed about a ferrite rod; U.S. Pat. No. 5,767,792, which discloses an antenna in a temperature sensing transponder formed by wrapping a coil around a ferrite rod; U.S. Pat. No. 6,400,338, owned by Digital Angel Corporation, the assignee of the present invention, discloses a unitary core formed of ferrite.

While prior art RFIDs are sometimes referred to as “integrated”, they are not actually fully integrated in the sense of an ‘integrated circuit chip’ but rather consist of multiple discrete parts. A feature of all of the prior art RFIDs references is that they are comprised of multiple discrete parts with nominal dimensions such as for example: 1) an integrated circuit chip that can typically measure 1.0 mm×1.2 to 1.4 mm×0.2 to 0.7 mm; 2) a core, consisting of ferrite or other material that can typically measure; 1.0 mm×7.0 to 11.0 mm×1.0 mm; 3) an antenna coil consisting of copper or silver wire coated with insulation wound around the core that can typically measure 1.5 mm×1.5 mm×6.0 to 8.0 mm; 4) metallic bonding pads and metallic bonding wires that can typically measure 3 mm, used to connect the antenna coil to the integrated circuit chip; and 5) a cylindrical glass or glass-equivalent capsule that can typically measure 2 mm (outside diameter)×12 mm (length) or other enclosure into which the assembly of integrated circuit chip, ferrite core, metallic bonding pads or metallic bonding wires and antenna coil is placed.

It is this prior art construction, comprising multiple discrete parts, which allows for void volumes within the RFID that sometimes cause failure of these RFIDs, due to moisture and ion accumulation, when these RFIDs are encapsulated in certain polymeric materials.

Because of the size and number of discrete parts, the prior art implantable RFID transponders are usually at least 2 mm in diameter and 12 mm in length. While prior art implantable RFID transponders may function and be appropriate for certain animals, they are nevertheless less than optimal when considered for implantation in humans, other animals or objects because they are still relatively large devices to implant. For example, a 12 gauge or larger needle is required to implant the 2 mm×12 mm RFID. A 12 gauge implantation needle creates a significant wound track, may leave a scar, puts the patient at risk for infection and can cause the implantation to be painful.

Accordingly, a need exists for a smaller integrated implantable RFID transponder that can be implanted within a human or other animal, without the pain and other drawbacks associated with a larger RFID.

### SUMMARY OF THE INVENTION

In view of the above discussion and the shortcomings of the present implantable RFIDs, the present invention seeks to overcome such shortcomings by creating an implantable RFID transponder, which is preferably more than a thousand times smaller in volume than prior art implantable RFIDs. In one embodiment of the present invention, an implantable RFID is provided, which is only 110 microns (110×10⁻⁶ meters) thick and by virtue of which can be implanted in the dermis (skin) of the patient rather than under the dermis thereby reducing implantation trauma and preferably does not migrate from the implantation location.

In one embodiment of the present invention, an implantable RFID is disclosed which is preferably completely integrated and which contains no discrete parts. In another embodiment, the RFID is completely solid and has zero void volumes thereby eliminating or hindering the risk of accumulation of diffused H₂O upon the integrated circuit.

In another embodiment of the present invention, a polymeric encapsulation, which is a barrier to ions, is used in making the RFID to eliminate the risk of corrosion of the integrated circuit. In yet another embodiment, a biocompatible conformal coating is applied directly to the integrated circuit die to maintain substantial decrease in volume. Moreover, in the RFID according to one embodiment of the present invention, a ferrite-free, integrated antenna is formed by the process used for under-bump metallization, where gold, titanium, aluminum, nickel-vanadium, copper or other suitable metal is sputtered, or conductive paste screened, onto the surface of the integrated circuit to form an antenna.

According to one embodiment of the present invention, the implantable RFID operates at gigahertz frequencies that reduce the required size of the antenna allowing it to be formed as part of the integrated circuit chip. In yet another embodiment, the RFID is glass free and which, by virtue of its polymeric conformal coating is substantially unbreakable compared to prior art glass and glass-equivalent encapsulated implantable RFIDs.

In yet another embodiment, the RFID is part of a medical information system for implanted medical devices and other medical information needs.

### BRIEF DESCRIPTION OF THE DRAWINGS

A further understanding of the present invention can be obtained by reference to the embodiments set forth in the illustrations of the accompanying drawings. The drawings are not necessarily drawn to scale and are not in any way intended to limit the scope of this invention, but merely to clarify and be illustrative of embodiments of the invention.

FIG. 1 is an isometric plan view of an implantable RFID constructed in accordance with one embodiment of the present invention;

FIG. 2 is a top view of an implantable RFID according to one embodiment of the present invention;

FIG. 3 is a cross section of an implantable RFID taken at line A-A of FIG. 2;

FIG. 4 is an isometric plan view of a liquid state coating practiced in the prior art;

FIG. 5 is a cross sectional view showing the relative relationship of an implantable RFID implanted in the dermis in RF communication with an RFID interrogator;

FIG. 6 is a diagram of one embodiment of an implantable RFID in a medical information system;

FIG. 7 is a block diagram of certain electronic sections of an implantable RFID according to one embodiment of the present invention;

FIG. 8 is a diagram showing the process of a poly-para-xylylene vapor deposition process and certain equipment used in said process according to one embodiment of the present invention;

FIG. 9 depicts an integrated circuit for use with an RFID according to one embodiment of the present invention with a terminal metallization pad and passivation layer;

FIG. 10 depicts an under-bump metallization according to one embodiment of the present invention;

FIG. 11 depicts the elements of FIG. 10 with a resist layer added;

FIG. 12 depicts the elements of FIG. 11 with a resist layer exposed and developed;

FIG. 13 depicts the elements of FIG. 12 with an under-bump metallization layer etched;

FIG. 14 depicts the elements of FIG. 13 with the resist layer removed to yield completed under-bump metallization layer patterned to form an integrated antenna;

FIG. 15 is a diagram depicting permeation of water and ions into void volumes occurring in prior art polymeric encapsulated RFIDs;

FIG. 16 is a diagram depicting a conformal coating, coated directly on an integrated circuit die according to one embodiment of the present invention; and

FIG. 17 depicts water molecules within a conformal coating at the integrated circuit surface.

### DETAILED DESCRIPTION OF THE PREFERRED EMBODIMENTS

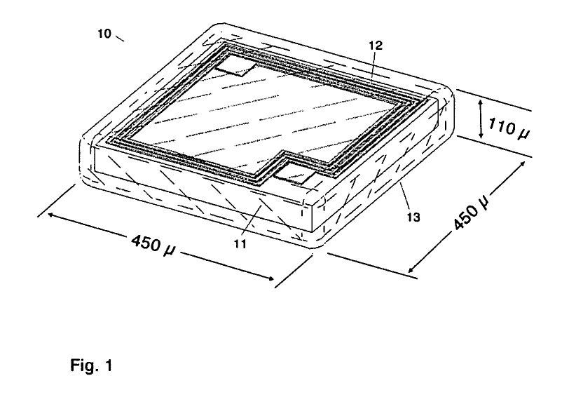

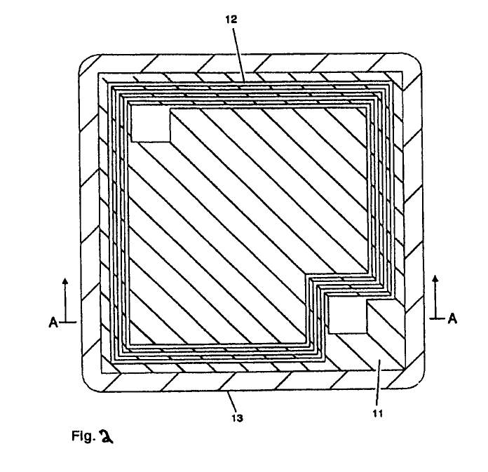

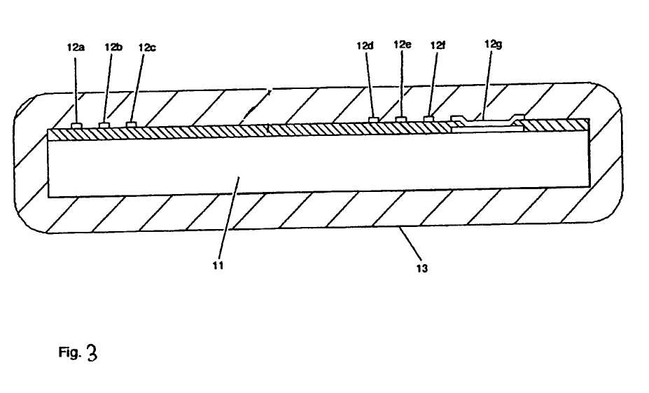

Referring to FIGS. 1, 2 and 3, a micro sized implantable RFID 10 is shown that is composed of an integrated circuit die 11 with integrated antenna 12, and biocompatible conformal coating 13. As shown in FIG. 2 and FIG. 3, the integrated antenna 12 is a metallic antenna deposited directly onto the integrated circuit die 11 by sputtering gold, silver, titanium, aluminum, nickel-vanadium, copper, or other suitable metals, either individually or in combinations, such as Al/NiV/Cu, or screening conductive paste which includes copper, palladium, or gold particles suspended in an organic binder, liquid carrier or polyimide upon the surface of the integrated circuit die 11 using the same process used for under-bump metallization of integrated circuits. Under-bump metallization, either by sputtering or screening, is a process well known in the art. One such example is in U.S. Pat. No. 6,992,001 entitled “Screen Print Under-Bump Metalization (UBM) To Produce Low Cost Flip Chip Substrate” which is incorporated herein by reference. More specifically, FIG. 2 shows a top view of the implantable RFID with the conformal coating 13 removed from the top surface to reveal the RFID chip and ferrite-free, integrated antenna 12. FIG. 3 shows integrated antenna elements that are formed by under-bump metallization and the application of the conformal coating as will be discussed below.

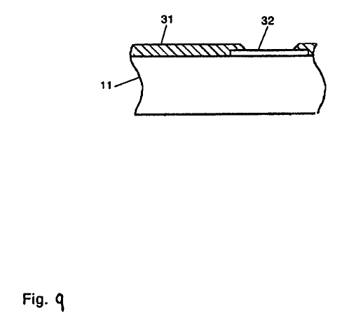

With reference to FIGS. 9-14, a sequence of steps used for forming the integrated antenna using under-bump metallization will now be discussed. First with reference to FIG. 9, an integrated circuit 11 that has passivation layer 31 is shown with a selectively removed area exposing terminal metallization pad 32. Passivation layer 31 may be comprised of various and or multiple layers of Silicon Nitride, Phospho Silicate Glass and other passivation layers.

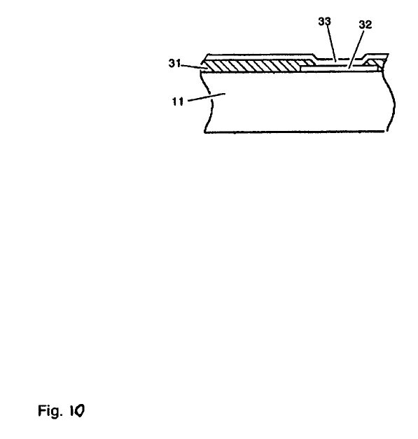

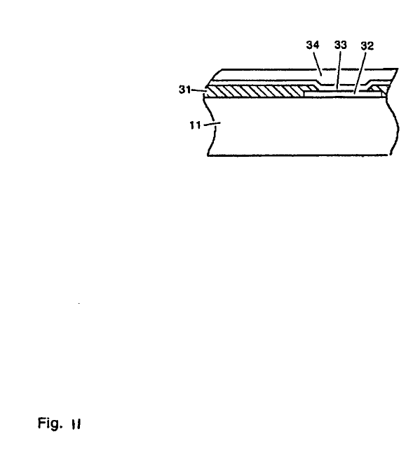

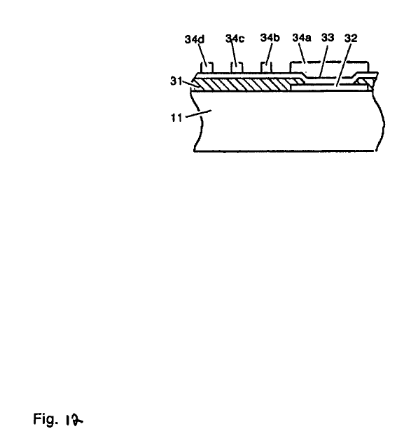

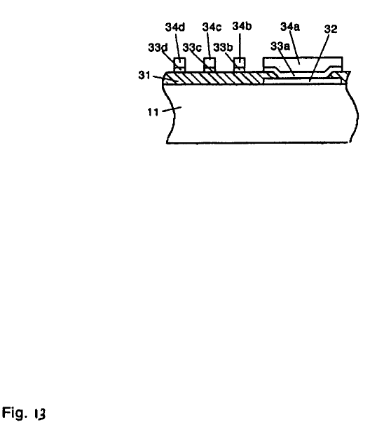

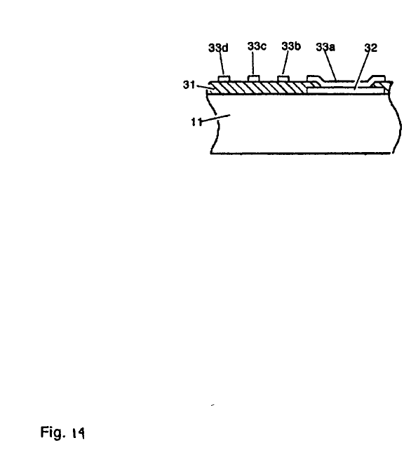

In FIG. 10, an under-bump metallization layer 33 is shown that has been sputtered or screened on the integrated circuit chip 11 on top of passivation layer 31 to come in contact with terminal metallization pad 32. Subsequently, as shown in FIG. 11, a resist layer 34 is deposited. As shown in FIG. 12, the resist layer 34 is exposed and developed to form the desired pattern as depicted by elements 34a, 34b, 34c, 34d. In FIG. 13, the under-bump metallization layer 33 is etched in the same pattern as the patterned resist layer 34a, 34b, 34c, 34d to form the pattern of the antenna 33a, 33b, 33c, 33d, using the under-bump metallization. Finally, as shown in FIG. 14, the resist layer 34a, 34b, 34c, 34d has been removed and the integrated antenna 12, formed by the residual elements 33a, 33b, 33c, 33d of the under-bump metallization, is completed.

The integrated antenna 12 is therefore not a discrete antenna, as are the various antenna coils in the prior art references, but rather is formed as part of the processes that forms the integrated circuit 11, and does not exist separately from the integrated circuit 11.

As further shown in FIG. 2 and FIG. 3 once the under-bump metallization process is performed, the biocompatible conformal coating 13 totally encompasses the integrated circuit die 11 and integrated antenna 12. As can be seen, there are preferably no ohmic connections to the integrated circuit die through the biocompatible conformal coating 13.

FIG. 3 further depicts antenna cross-sections 12a-12g totally encompassed by biocompatible conformal coating 13. According to this embodiment, the implantable RFID is preferably completely solid and contains no void volumes which would allow any moisture, that may permeate the conformal biocompatible coating, to collect and electronically short out the integrated circuit. The biocompatible conformal coating 13 is preferably composed of poly-para-xylylene, which is commercially available under the name Parylene, and more specifically the type known as Parylene C. Parylene C is known in the art as a completely linear, highly crystalline polymeric material that has proven biocompatibility. The chemical formula for Parylene C is

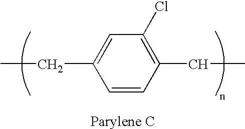

In other embodiments other polymeric materials, which are equivalent to Parylene C can also be used.

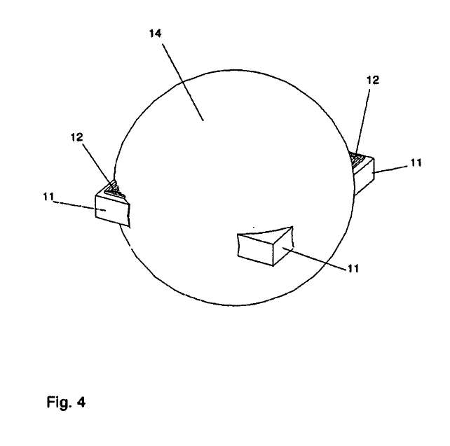

Referring now to FIG. 4, the results of the methods of applying the coating in a liquid form is shown. When thin coatings are applied in liquid form and as the part dimensions become microscopic, the forces of surface tension tend to dominate the liquid coating, pulling it into a spherical shape 14. As depicted in FIG. 4, coating materials 14 which are applied in a liquid state are subject to surface tension forces of the liquid and leave sharp points such as corners 11 exposed. This makes it impractical to try to apply a thin conformal coating to a part that is as small as the 400 micron×400 micron×60 micron integrated circuit die using liquid coatings. The nominal size of the integrated circuit die 11 is 400 microns square by 60 microns thick. In contrast as will be discussed below, in the present invention, the conformal coating is applied in a vapor state which avoids the problems associated with the liquid coatings of the prior art.

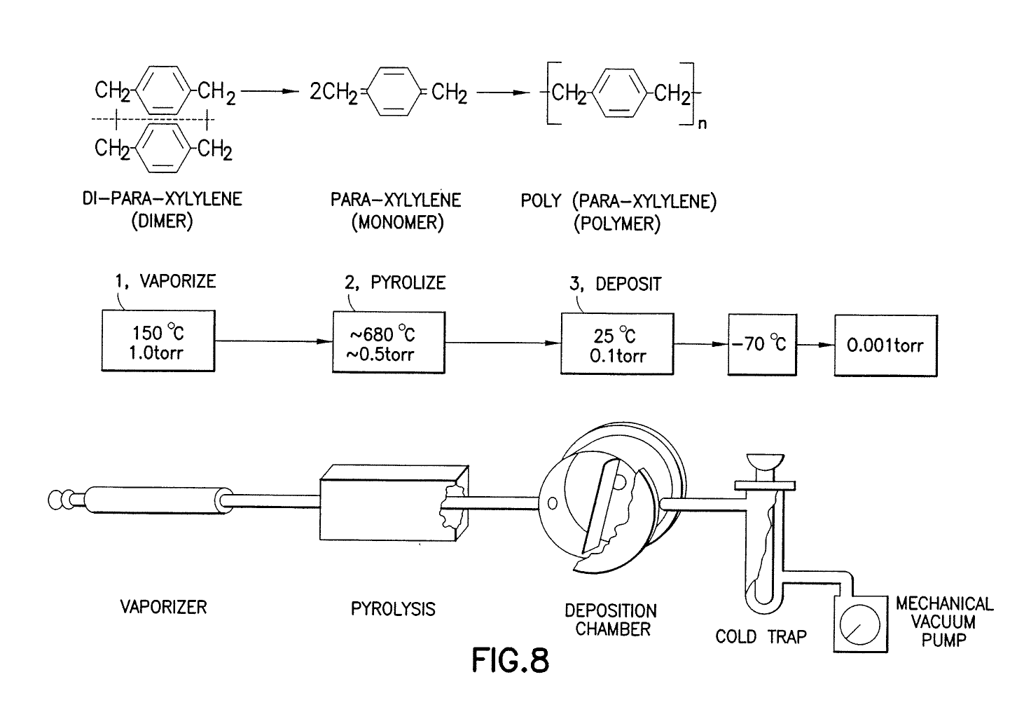

FIG. 8 further depicts the production and coating process for poly-para-xylylene in one embodiment of the present invention. As can be further seen in FIG. 8, the Di-para-xylylene dimer is vaporized in a vaporizer at an approximate temperature of 150 degrees Celsius at a pressure of 1.0 Torr. The resulting monomer para-xylylene goes under the process of pyrolysis at an approximate temperature of 680 degrees Celsius and a pressure at approximately 0.5 Torr. This results in the polymer Poly(para-xylylene) which is deposited in the Deposition Chamber at 25 degrees Celsius and a pressure 0.1 Torr. The resulting compound is then deposited in a Cold Trap at an approximate temperature of negative seventy degrees Celsius and a mechanical vacuum pump is used to create a pressure of 0.001 Torr.

In general, according to Specialty Coating Systems, the leading manufacturer of Parylene, a Parylene medical coating provides an inert biocompatible barrier to chemicals, moisture and biofluids. Parylene adds dry film lubricity, and is recognized as a Class VI polymer by the FDA. Because Parylene's polymeric backbone is made entirely of carbon, Parylene is not vulnerable to hydrolytic breakdown in the corrosive aqueous implantation environment as other polymers used for coating. Hence, Parylene is highly regarded in the field of medicine as a candidate for implantation survival. In the vapor deposition process (VDP), a highly reactive monomer spontaneously polymerizes at room temperature without need for a catalyst. Conventional coating systems that are dipped, sprayed, or brushed require catalysts and elevated temperature cure cycles to improve coating properties to acceptable levels. Since Parylene coatings require no elevated temperature cure cycle, there are no associated cure stresses. Other coating systems may start with proprietary formulations that include solvents, fillers, stabilizers, plasticizers, and the like. Along with the chemical residues of the polymerization catalyst, these ingredients represent potentially mobile components in the final coatings deposit in a predictable and understandable manner. The thickness of Parylene coatings is controllable from below 100 nanometers to several millimeters. Parylene coatings can provide strength and support to very thin, fragile substrates. Parylene contributes these properties with minimal mass because the required coating thickness can be applied reliably to all surfaces.

According to FDA studies, Parylene C is certified to comply with the USP biological testing requirements for Class VI Plastics, which include Acute Systemic Toxicity, Irritation/Intracutaneous Reactivity, and Implantation. Culture studies using diploid WI-38 embryonic human lung cells have demonstrated that Parylene C coatings are highly compatible with living cells, with little evidence of cytotoxicity. In vitro tissue culture studies show that human cell types readily proliferate on Parylene C coated surfaces to produce thin, adherent layers of morphologically normal tissue. Successful in vivo cell growth studies have also been reported. Parylene C has been used to coat and anchor experimental fabrics used as scaffolding for the growth of blood compatible intimal linings of experimental circulatory assist devices. The acute toxicity of the Parylene dimers, the precursor materials used to prepare Parylene coatings have also been found to be low. Functionally, Parylene has been shown to be a pinhole-free barrier against moisture, chemical, and biofluid and biogases.”

Due to the vapor phase deposition process, which is used for its application, the Parylene polymers can be formed as structurally continuous conformal coating as thin as one hundred nanometers (100×10⁻⁹M). For example the biocompatible conformal coating 13 of the preferred embodiment of the present invention shown in FIGS. 1-3 is preferably 25 microns (25×10⁻⁶M) thick and is deposited by vapor phase deposition directly onto the integrated circuit die 11. This thickness includes integrated antenna 12.

It should be noted that Parylene has rarely if ever been observed in a liquid state. Parylene polymerizes into the solid poly-para-xylylene directly from the monoremic vapor phase. It is this feature which helps make it possible to conformably coat the integrated circuit die such that there are no void volumes or pinholes in the coating.

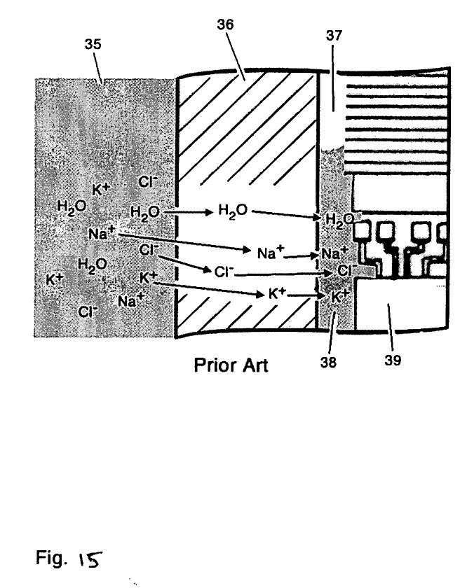

Referring to FIG. 15, when prior art RFIDs were implanted, biofluid 35 comprising water and various ions (including but not limited to the ions in FIG. 15) contacted prior art polymeric encapsulation 36 of prior art RFIDs. These prior art RFIDs generally were constructed in a manner which resulted in void volumes 37 to be formed within the RFID and the various electronic components 39. These void volumes 37 allowed for the water and ions contained in the biofluid 35 to permeate the polymeric encapsulation and collect to form conductive and corrosive liquid 38, which ultimately contacted electronic components 39 resulting in the failure of the prior art RFID. This failure of polymeric encapsulation has led most RFIDs to be encapsulated in glass or its equivalents.

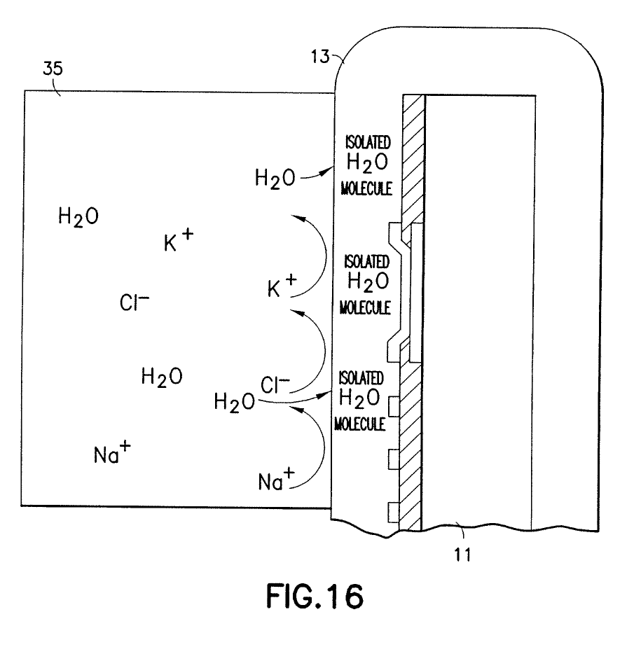

Referring to FIG. 16, Parylene C has been polymerized directly onto the integrated circuit die using a vapor phase deposition process such that the Parylene C used to form conformal coating 13 is intimately bound at the molecular level to the surface of the integrated circuit die 11 and antenna 12. Unlike prior art polymeric encapsulation, Parylene C conformal coating is not permeable to ions thus enabling a conformal coating that is not subject to the corrosion problems of the prior art encapsulation.

As shown in FIG. 16, when biofluid 35 containing water and various ions contacts the Parylene C conformal coating 13 the ions do not permeate. Although Parylene C is slightly permeable to water, due to the fully integrated construction of the RFID of the present invention, which contains no voids, there is nowhere for the water to permeate to and condense as a liquid. Therefore, the result is that water only exists as diffused individual H₂O molecules within the Parylene C conformal coating 13 polymeric structure. It should be noted that the integrated circuit die 11 is neither exposed to ions nor to liquid water. Under these conditions, the Parylene C conformal coating 13 is functionally hermetic with regard to the integrated circuit die 11.

Preferable specifications for Parylene C used in the encapsulation method of the present invention include insulation resistance (ohms), MIL-STD-202, method 302, where a 0.001 inch thickness (25 microns) retained after 10 days of daily 7 step cycles from 23 C, 50% RH to 65 C, 90RH, a resistance of 6.3×10¹² ohms.

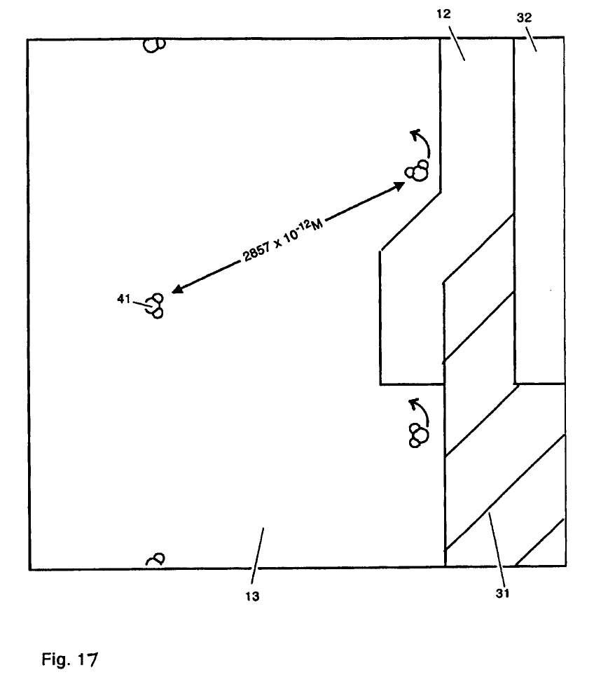

FIG. 17 depicts water content of the Parylene C conformal coating 13 at equilibrium after 24 hours. Water absorption at equilibrium after 24 hours for Parylene C is specified at 0.1% by weight. This results in a calculated mean distance between each H₂O molecule 41 of [2857×10⁻¹²M]. In liquid water the bond length of the hydrogen bonds between H₂O molecules is [117×10⁻¹²M], therefore the distance of 2857×10⁻¹²M between H₂O molecules in the Parylene C layer precludes hydrogen bonding and liquid water from existing. As further depicted in FIG. 17 both the under-bump metallization of the antenna 12 and the passivation layer 31 are not permeable to the isolated H₂O molecules. It is preferable that the antenna 12, formed by under-bump metallization and the passivation layer 31 are not exposed to liquid water or various ions typically found in biofluid.

There are a variety of methods in which to effect the vapor phase deposition of poly-para-xylylene. For example, U.S. Pat. No. 4,508,760, entitled “Method And Apparatus For Microencapsulation”; U.S. Pat. No. 4,758,288, entitled “Encapsulated Lithium Granules And Method Of Manufacture”; and U.S. Pat. No. 5,201,956, entitled “Cellular Tumble Coater”, which are each incorporated herein by reference, disclose creating a coating by using the vapor phase deposition of poly-para-xylylene.

In one method of effecting the vapor phase of poly-para-xylylene, the integrated circuit dies can be exposed to the monomeric para-xylylene vapor using a barrel method of application, in which the integrated circuit dies are slowly tumbled in a “barrel” within the vacuum chamber so that all of the surfaces of integrated circuit dies are exposed to the monomeric para-xylylene vapor and thus acquire a conformal coating of poly-para-xylylene of uniform thickness throughout the integrated circuit.

It should be appreciated that after a conformal coating of nominally 25 microns in the thickness of Parylene C is deposited according to this embodiment of the present invention, the total of the conformal coating and the implantable RFID is only 450 microns×450 microns×110 microns. This yields a total volume of only 22 nanoliters (22×10⁻⁹ liters) for the preferred volume of the RFID according to one embodiment of the present invention. Twenty-two nanoliters is 1,713 times smaller in volume than typical prior art implantable RFIDs, the smallest of which typically has a volume of 37.7 microliters (37.7×10⁻⁶ liters). A 1,713 fold smaller volume causes significantly less trauma at the implantation site, making the implantable RFID of the present invention much easier and safer to implant. Further its micron-scale allows for it to be implanted directly in the dermis (skin), as opposed to under it. This feature helps insure that the implant will not migrate, unlike larger implants which must be implanted under the skin in the adipose tissue above muscle and which have been shown to migrate from the original implant site in certain instances. Additionally, should the implantable RFID of the present invention need to be removed or moved, its location in the dermis (skin) provides far less trauma during removal or movement of the device.

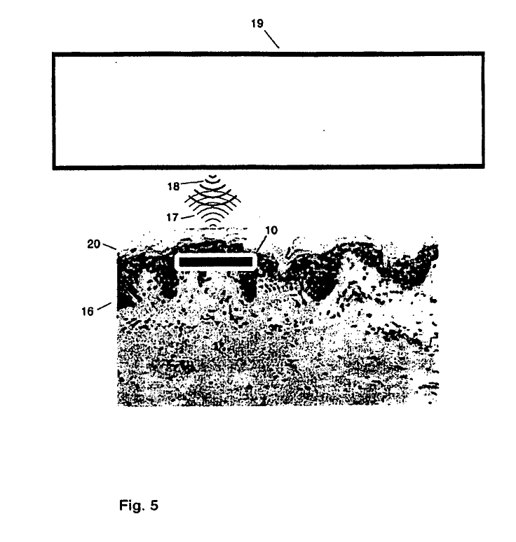

Referring to FIG. 5, according to one embodiment of the present invention, the implantable RFID of the present invention is implanted under the epidermal layer 20 in the dermis 16. An RFID interrogator 19 transmits a first RF signal to the micron-scale RFID 10, which derives power from the received signal and subsequently transmits a second RF signal 17, which contains the encoded data. The nominal frequency of this embodiment is preferably 2.45 gigahertz (2.45×10⁹ Hertz) and the data is a 128 bit number.

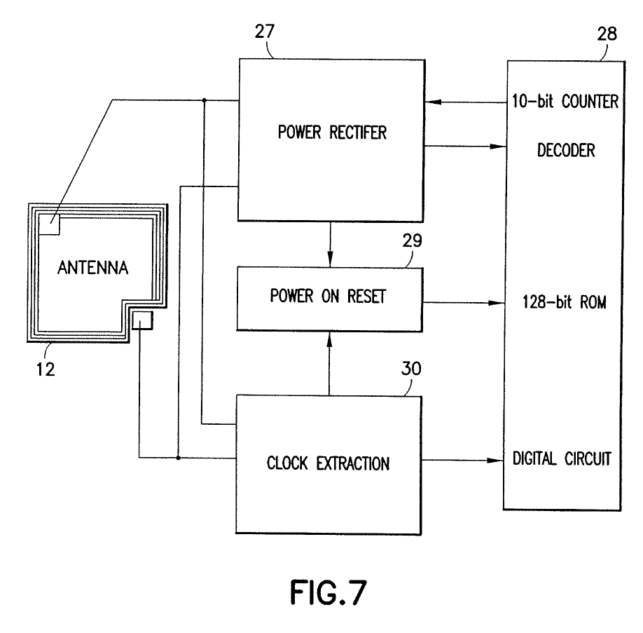

Referring to FIG. 7, the major analog and digital sections of the integrated circuit chip 11, are shown including, integrated antenna 12; power rectifier 27; processor 28 which preferably includes a 10-bit counter, decoder, 128-bit ROM and digital circuit; power on reset 29; and clock extraction 39. Preferably a circuit chip, such as that manufactured by Hitachi Ltd., using the above frequencies is used in accordance with the present invention. It should be appreciated that this is a design choice and other chips using different frequencies may be employed as well.

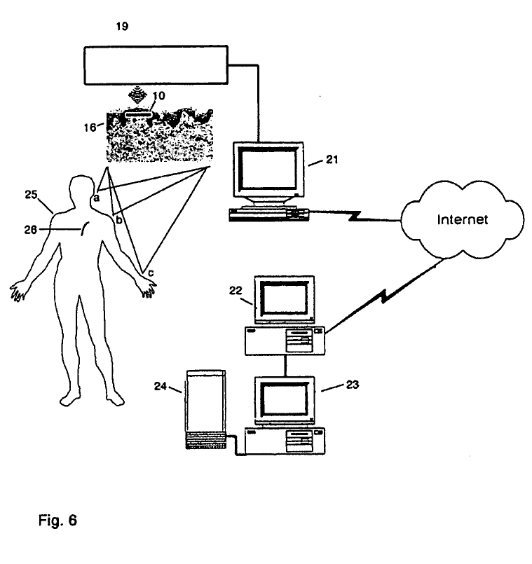

Referring to FIG. 6 one embodiment of an implantable RFID of the present invention includes an information system where the RFID 10 is implanted in the dermis 16 of patient 25 who has a separate medical device 26 implanted in their body. Various systems have been disclosed in the prior art for inserting an RFID tag into a medical device. For example, U.S. Pat. No. 5,423,334 entitled “Implantable Medical Device Characterization System” which is incorporated herein by reference discloses one such method where the RFID is installed into the medical device such that the RFID and medical device are a single unit. This method is less than optimal for several reasons. While some implantable medical devices can accommodate an RFID within them, others such as stents or vascular grafts, for example, are generally not suited for incorporation of an RFID. Another problem is that by incorporating the RFID in the implanted medical device each medical manufacturer would have their own proprietary system and this would make adoption confusing, expensive and impractical for healthcare providers. Still another problem in incorporating the RFID into the medical device is that medical devices that were implanted without the RFID could not be included in such a system.

The RFID of the present invention overcomes these problems because of its extremely small size. This size does not limit where the RFID can be placed and rather the RFID can be implanted in any suitable location in the dermis, shown in FIG. 6 by way of example, as (a) or (b) or (c), of any patient at any time. Thus a single RFID information system, accessed the same way by any healthcare professional regardless of the type of implanted medical device, can be developed using the RFID of the present invention and accessed by a health care professional.

Referring to FIG. 6, in operation, a healthcare professional would use an interrogator 19 to acquire a unique serial number (or other data) from implantable RFID 10 using known methods. The interrogator 19 would preferably be connected to a client computer 21 which would communicate over the internet (or other Network or intranet system including but not limited to a Local Area Network (LAN) or Wide Area Network (WAN)) to web server 22 which would access the database server 23 and database 24 to acquire the pertinent medical information about the specific device 26 and/or specific patient 25, as tracked by the unique serial number transmitted by implantable RFID 10. The web server 22, database server 23, and database 24 could be operated by the manufacturer of the implanted medical device 26 or could be operated by another entity, as allowed by the Center for Devises and Radiological Health of the FDA. Additionally the servers can be combined into one system or be discrete computer components. Moreover the database 24 may be divided into various discrete databases for storing various different information about the patient and/or device as is known in the art.

Those skilled in the art will recognize that the method and system of the present invention has many applications, may be implemented in many manners and, as such is not to be limited by the foregoing exemplary embodiments and examples. In this regard, any number of the features of the different embodiments described herein may be combined into one single embodiment and alternate embodiments having fewer than all of the features are possible. Moreover, the scope of the present invention covers conventionally known and future developed variations and modifications to the system components described herein as would be understood by those skilled in the art.

1. An integrated implantable transponder that is made out of a single chip, the transponder comprising:
an integrated circuit comprising one or more passivation layers;
an antenna integrally formed on said integrated circuit by sputtering one or more metallic materials directly onto the integrated circuit; and
a conformal coating covering said integrated circuit and said antenna, said conformal coating comprising a polymeric substance whose backbone is entirely carbon and wherein the conformal coating is applied to the transponder in a vapor state to hermetically seal the transponder.

2. The implantable transponder of claim 1 wherein the conformal coating completely encapsulates the integrated circuit and the integrated antenna.

3. The implantable transponder of claim 1 wherein the conformal coating comprises a para-xylylene.

4. The implantable transponder of claim 3 wherein the para-xylylene is Parylene C.

5. The implantable transponder of claim 1 wherein the one or more metallic materials are screened onto the integrated circuit.

6. The implantable transponder of claim 1 wherein the integrated antenna is inseparable from the integrated circuit.

7. The implantable transponder of claim 1 wherein the transponder comprises a polymeric encapsulation that reduces corrosion in the integrated circuit.

8. The implantable transponder of claim 1 wherein the transponder operates at a range between 2.35 and 2.55 gigahertz.

9. The implantable transponder of claim 1 wherein the transponder is glass free.

10. The implantable transponder of claim 1 wherein the transponder is capable of being implanted into a living being or nonliving matter.

11. A method of creating an implantable transponder comprising the steps of:
forming an integrated antenna within the implantable transponder by applying an under-bump metallization layer onto an integrated circuit that consists of one or more passivation layers;
applying a conformal coating to the integrated circuit by polymerizing a polymer substance whose backbone is entirely carbon;
applying the conformal coating to the transponder to hermetically seal the transponder while the conformal coating is in a vapor state; and
encapsulating the polymer integrated antenna onto the integrated circuit.

12. The method of claim 11 wherein the implantable transponder is capable of being implanted into a living being or nonliving matter.

13. The method of claim 11 wherein the conformal coating comprises a para-xylylene.

14. The method of claim 13 wherein the para-xylylene is Parylene C.

15. The method of claim 11 wherein the integrated antenna is further formed by sputtering one or more metallic materials directly onto the integrated circuit.

16. The method of claim 11 wherein the integrated antenna is further formed by screening one or more metallic materials directly onto the integrated circuit.

17. The method of claim 11 wherein the implantable transponder comprises a polymeric encapsulation that reduces corrosion in the integrated circuit.
